(19) United States
(12) Patent Application Publication
(10) Pub. No.: US 2005/0262250 A1
(43) Pub. Date: Nov. 24, 2005

(54) Messaging protocol

(76) Inventors: Brannon J. Batson, Santa Cruz, CA (US); Ling Cen, Austin, TX (US); William A. Welch, San Jose, CA (US); Herbert Hum, Portland, OR (US); Seungjoon Park, Los Altos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/833,965

(22) Filed: Apr. 27, 2004

(51) Int. Cl. G06F 15/16

(52) U.S. Cl. 709/230

(57) ABSTRACT

The invention facilitates a messaging protocol in a multi-node system to resolve conflicts at a home node.

### RELATED APPLICATIONS

The present U.S. patent application is related to the following U.S. patent applications:

(1) application Ser. No. 10/XXX,XXX (Docket No. P13923), filed ______, 2003, entitled “SPECULATIVE DISTRIBUTED CONFLICT RESOLUTION FOR A CACHE COHERENCY PROTOCOL”

(2) application Ser. No. 10/XXX,XXX (Docket No. P15925), filed concurrently with this application and entitled “A TWO-HOP CACHE COHERENCY PROTOCOL”

(3) application Ser. No. 10/XXX,XXX (Docket No.P18891), filed concurrently with this application and entitled “A CACHE COHERENCE PROTOCOL”

### FIELD

The invention relates to high-speed point-to-point link networks. More particularly, the invention relates to primitives for establishing a messaging protocol for systems ranging from a single-socket up through and greater than sixty four socket segments.

### BACKGROUND

When an electronic system includes multiple cache memories, the validity of the data available for use must be maintained. This is typically accomplished by manipulating data according to a cache coherency protocol. As the number of caches and/or processors increases, the complexity of maintaining cache coherency also increases.

When multiple components (e.g., a cache memory, a processor) request the same block of data the conflict between the multiple components must be resolved in a manner that maintains the validity of the data. Current cache coherency protocols typically have a single component that is responsible for conflict resolution. However, as the complexity of the system increases, reliance on a single component for conflict resolution can decrease overall system performance.

A messaging protocol defines a set of allowed messages between agents, such as, caching and home agents. Likewise, the messaging protocol allows for a permissive set of valid message interleavings. However, the messaging protocol is not equivalent to a cache coherence protocol. In contrast, the messaging protocol serves the purpose of establishing the “words and grammar of the language”. Consequently, the messaging protocol defines the set of messages that caching agents must send and receive during various phases of a transaction. In contrast to a messaging protocol, an algorithm (cache coherence protocol) for coordinating and organizing the requests, resolving conflicts, and interacting with caching agents.

There are two basic schemes for providing cache coherence, snooping (now often called Symmetric MultiProcessing SMP) and directories (often called Distributed Shared Memory DSM). The fundamental difference has to do with placement and access to the meta-information, that is, the information about where copies of a cache line are stored.

For snooping caches the information is distributed with the cached copies themselves, that is, each valid copy of a cache line is held by a unit that must recognize its responsibility whenever any node requests permission to access the cache line in a new way. Someplace—usually at a fixed location—is a repository where the data is stored when it is uncached. This location may contain a valid copy even when the line is cached. However, the location of this node is generally unknown to requesting nodes—the requesting nodes simply broadcast the address of a requested cache line, along with permissions needed, and all nodes that might have a copy must respond to assure that consistency is maintained, with the node containing the uncached copy responding if no other (peer) node responds.

For directory-based schemes, in addition to a fixed place where the uncached data is stored, there is a fixed location, the directory, indicating where cached copies reside. In order to access a cache line in a new way, a node must communicate with the node containing the directory, which is usually the same node containing the uncached data repository, thus allowing the responding node to provide the data when the main storage copy is valid. Such a node is referred to as the Home node.

The directory may be distributed in two ways. First, main storage data (the uncached repository) is often distributed among nodes, with the directory distributed in the same way. Secondly, the meta-information itself may be distributed, keeping at the Home node as little information as whether the line is cached, and if so, where a single copy resides. SCI, for example, uses this scheme, with each node that contains a cached copy maintaining links to other nodes with cached copies, thus collectively maintaining a complete directory.

Snooping schemes rely on broadcast, because there is no single place where the meta-information is held, so all nodes must be notified of each query, each node being responsible for doing its part to assure that coherence is maintained. This includes intervention messages, informing the Home node not to respond when another node is providing the data.

Snooping schemes have the advantage that responses can be direct and quick, but do not scale well because all nodes are required to observe all queries. Directory schemes are inherently more scalable, but require more complex responses, often involving three nodes in point-to-point communications.

### BRIEF DESCRIPTION OF THE DRAWINGS

The invention is illustrated by way of example, and not by way of limitation, in the figures of the accompanying drawings in which like reference numerals refer to similar elements.

FIG. 1 is a protocol architecture as utilized by one embodiment.

Table 1 provides one embodiment of a plurality of message fields.

Table 2 provides one embodiment for a plurality of snoop messages.

Table 3 provides one embodiment for a plurality of request messages.

Table 4 provides one embodiment for a plurality of writeback marker messages.

Table 5 provides one embodiment for a plurality of snoop responses.

Table 6 provides one embodiment for an acknowledgment message.

Table 7 provides one embodiment for a plurality of response channel data messages.

Table 8 provides one embodiment for a plurality of response channel grant messages.

Table 9 provides one embodiment for a plurality of response channel completions and forces messages.

Table 10 provides one embodiment for a plurality of cache states for particular cache line.

FIG. 2 is a flowchart to depict a caching agent's response to a snoop as utilized by one embodiment.

Table 11 is one embodiment of a peer caching agent's response to a snoop when the peer agent does not have a conflicting outstanding request.

Table 12 is one embodiment of a peer caching agent's response to a snoop when the peer agent does have a conflicting outstanding request.

Table 13 is one embodiment of a plurality of state transitions in response to an incoming Cmp_Fwd.

FIG. 3 is multiple embodiments of a system.

### DETAILED DESCRIPTION

Techniques for a messaging protocol in a multi-node system are described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

As previously noted, the claimed subject matter incorporates several innovative features from the related applications. For example, the claimed subject matter references the Forward state (F-state) from the related application entitled SPECULATIVE DISTRIBUTED CONFLICT RESOLUTION FOR A CACHE COHERENCY PROTOCOL. Likewise, the claimed subject matter utilizes conflict tracking at the home agent for various situations, which is discussed in connection with application P15925, filed concurrently with this application and entitled “A TWO-HOP CACHE COHERENCY PROTOCOL”. Finally, the claimed subject matter utilizes various features of the cache coherency protocol depicted in application P18891, filed concurrently with this application and also entitled “A TWO-HOP CACHE COHERENCY PROTOCOL”. However, various features of the related applications are utilized throughout this application and we will discuss them as needed. The preceding examples of references were merely illustrative.

The discussion that follows is provided in terms of nodes within a multi-node system. In one embodiment, a node includes a processor having an internal cache memory, an external cache memory and/or an external memory. In an alternate embodiment, a node is an electronic system (e.g., computer system, mobile device) interconnected with other electronic systems. Other types of node configurations can also be used.

The claimed subject matter facilitates distributed cache coherency conflict resolution in a multi-node system by utilizing the messaging protocol that will be described. In one aspect, the claimed subject matter allows for several cache coherence protocols, which address different segments, to be created from the proposed messaging protocol described.

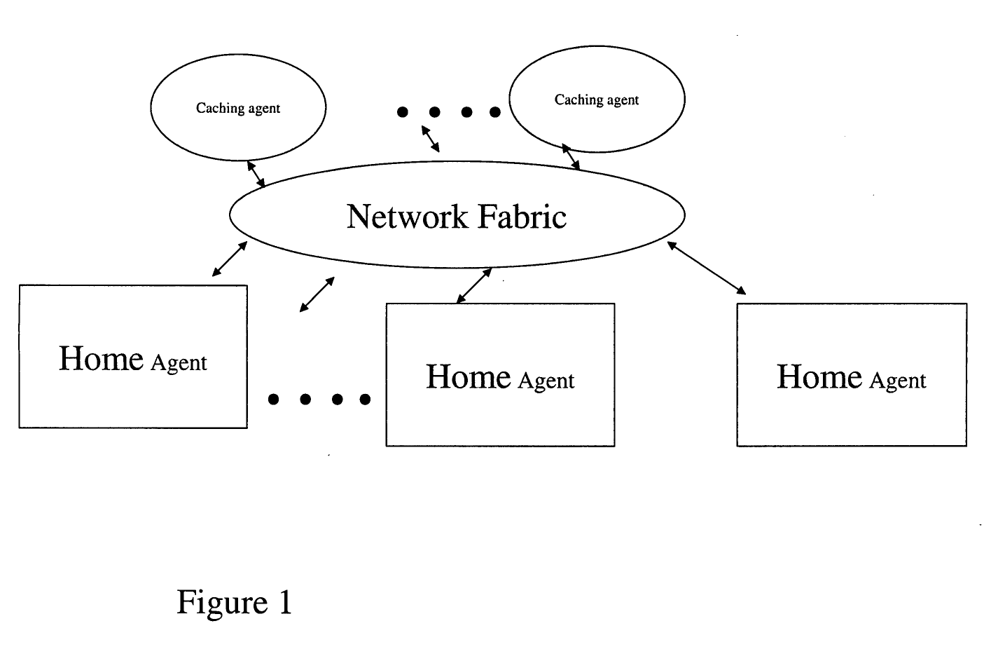

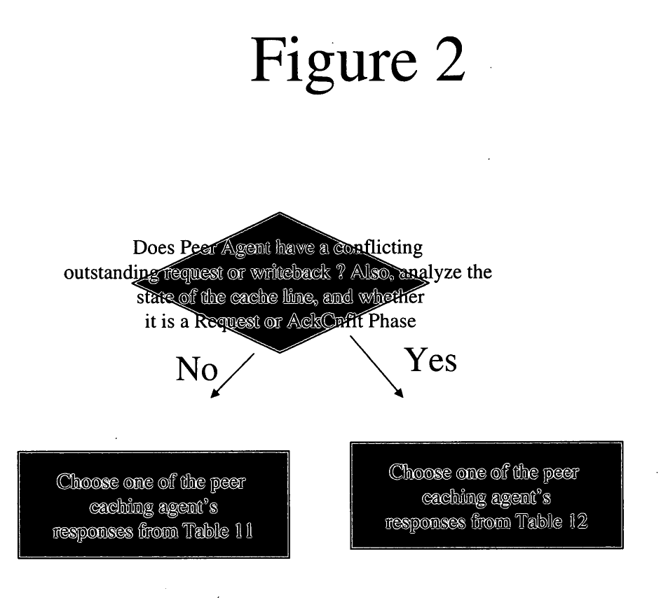

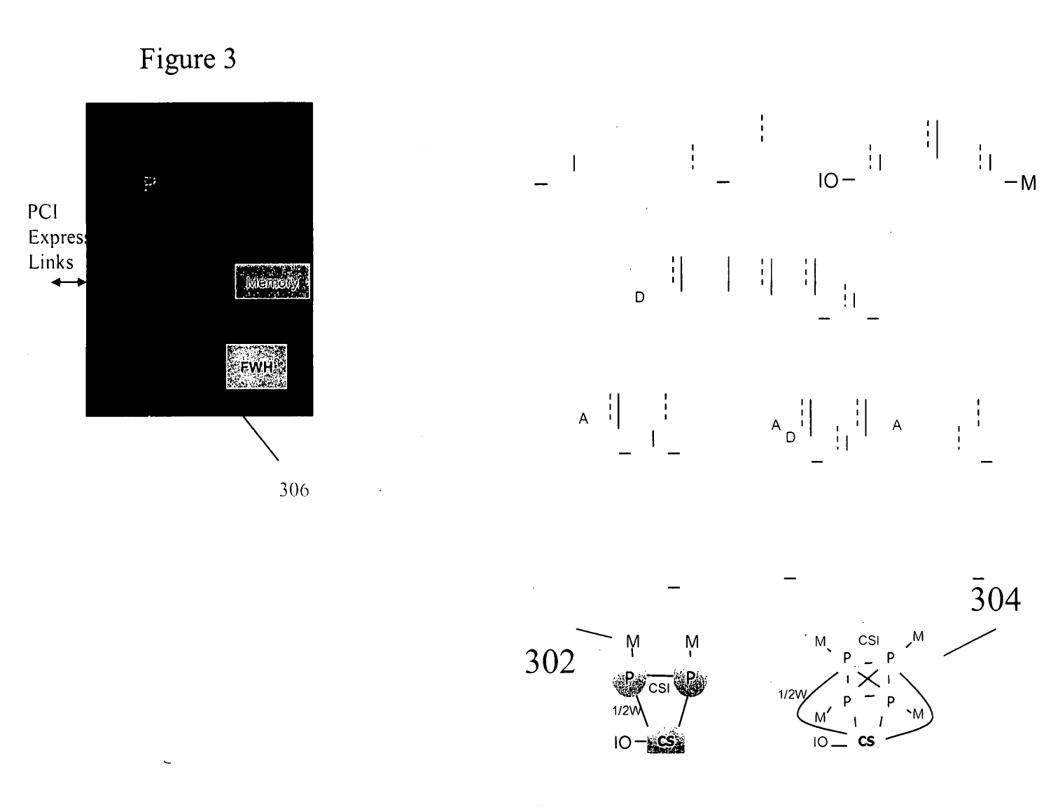

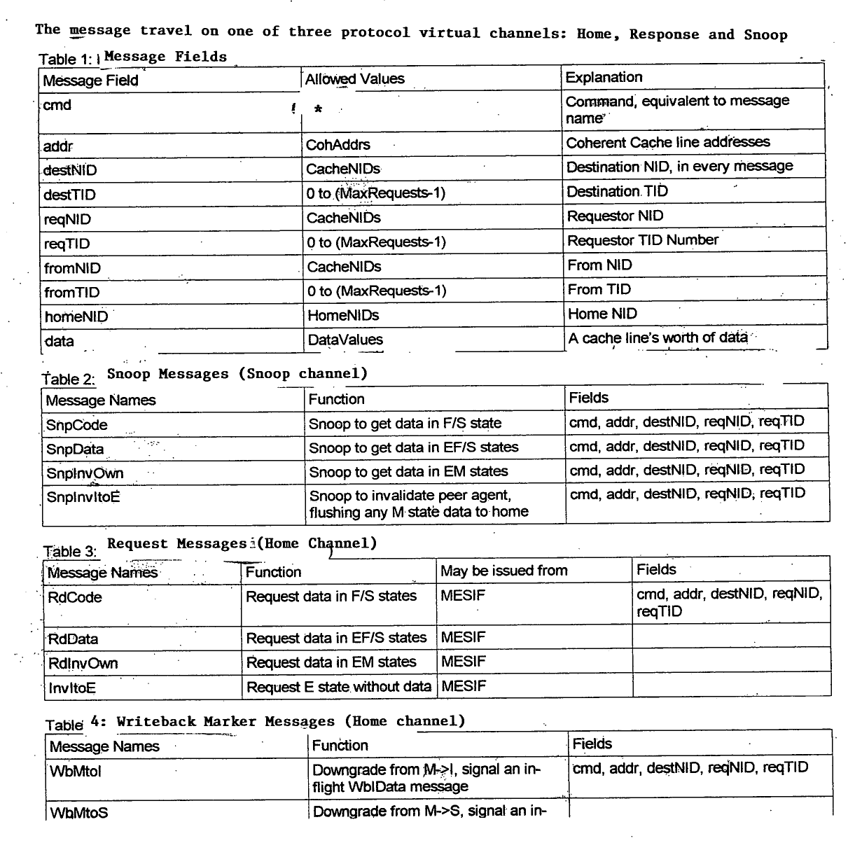

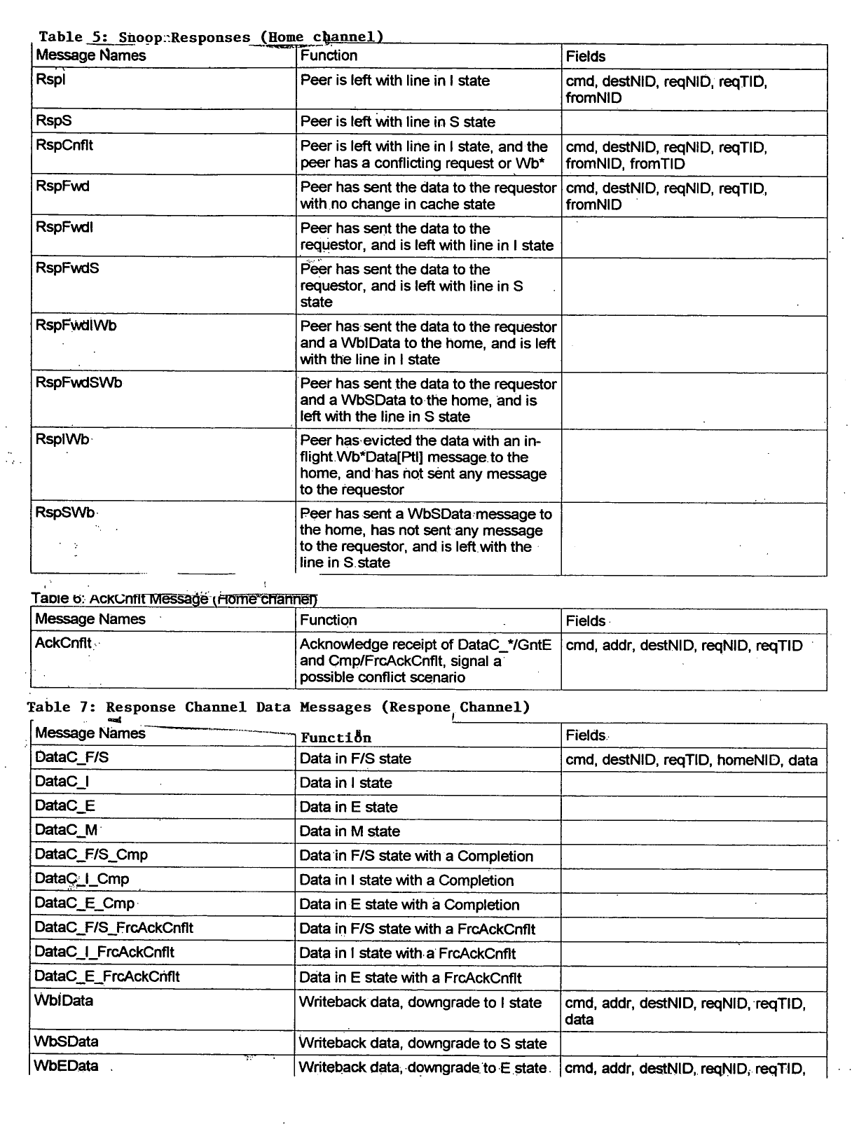

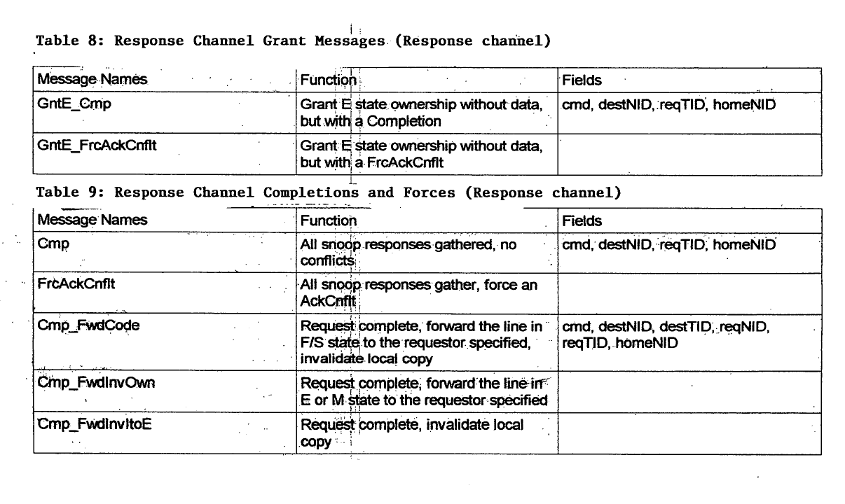

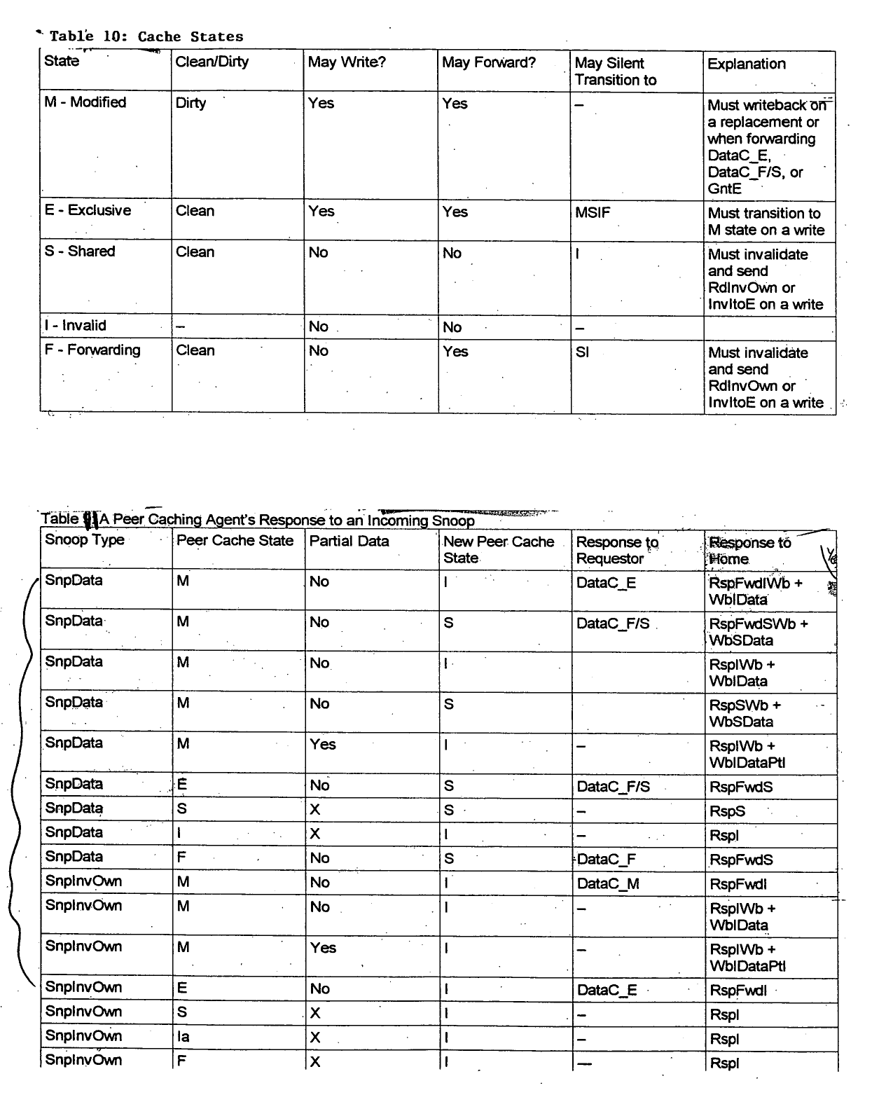

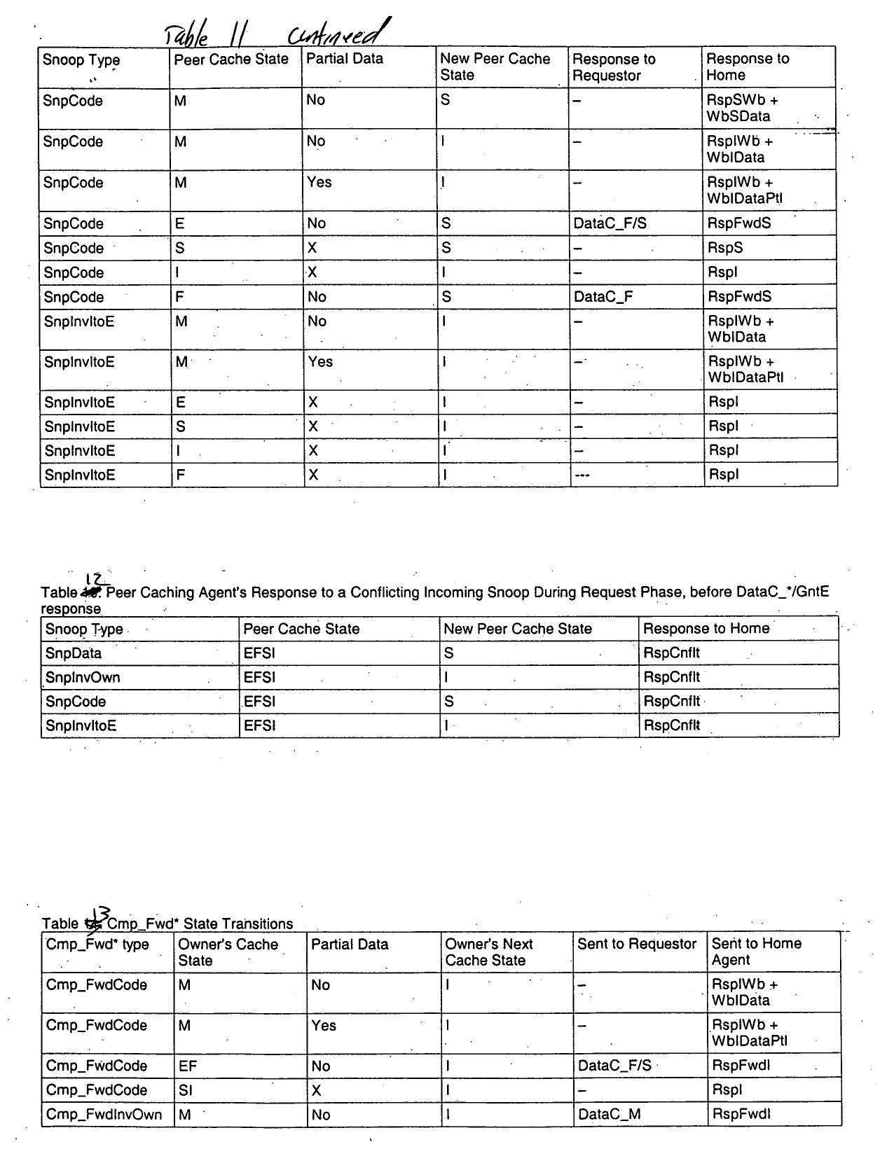

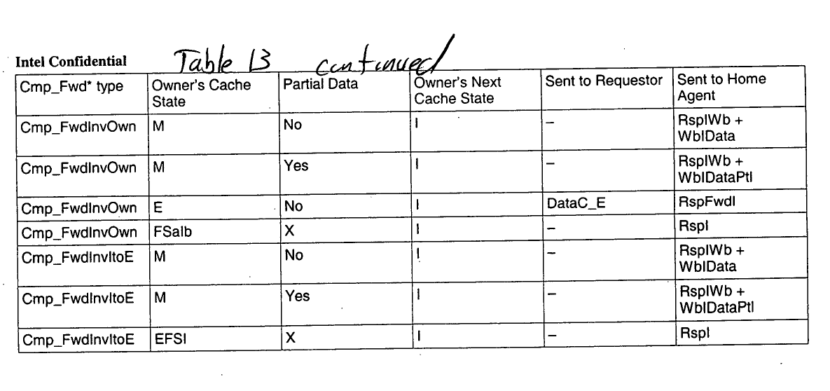

In one embodiment, a cache coherence protocol utilized with the described messaging protocol, defines the operation of two agent types, a caching agent and a home agent. For example, FIG. 1 is a protocol architecture as utilized by one embodiment. The architecture depicts a plurality of caching agents and home agents coupled to a network fabric. For example, the network fabric adheres to a layered protocol scheme and may comprise either or all of: a link layer, a physical layer, a protocol layer, a routing layer, a transport layer. The fabric facilitates transporting messages from one protocol (home or caching agent) to another protocol for a point to point network. In one aspect, the figure depicts a cache coherence protocol's abstract view of the underlying network.

In this embodiment, the caching agent:

1) makes read and write requests into coherent memory space

2) hold cached copies of pieces of the coherent memory space

3) supplies the cached copies to other caching agents.

Also, in this embodiment, the home agent guards a piece of the coherent memory space and performs the following duties:

1) tracking cache state transitions from caching agents

2) managing conflicts amongst caching agents

3) interfacing to a memory, such as, a dynamic random access memory (DRAM)

4) providing data and/or ownership in response to a request (if the caching agent has not responded).

In one embodiment, a cache coherence protocol recognizes three protocol classes of messages, regardless of how the protocol classes map to low level virtual channels. For example, the message dependencies are calculated within and across the protocol channels and are called Snoop, Home, and Response.

The snoop messages that travel on the snoop protocol channel may have a dependency on Home messages and responses. In contrast, the home messages may have a dependency on Responses. Therefore, the protocol hierarchy is Snoop->Home ->Response.

In one embodiment, the Home messages travel on the per-address in-order home channel. Therefore, a caching agent may block forward progress on the snoop channel while waiting for credits to send a home or response channel message without deadlock.

In one embodiment, the messaging protocol utilizes the following message names and their associated abbreviations as depicted in Table 1. For example, the addr message field has an allowed value of “cohAddrs”. In one embodiment, the cohAddrs is a profile and configuration specific set of allowable cache line addresses within a system or partition.

In one embodiment, the “cacheNids” is a profile and configuration specific set of caching agent NIDs within a system, wherein NIDs is an unique network identifier. Also, “homenids” is a profile and configuration specific set of home NIDs within a system. In this same embodiment, “DataValues” is a set of allowed data values in the system. For example, it may be all possible values of a cache line. Finally, the mask message field has an allowed value of “bytemasks”. The bytemask allowed value defines a set of allowed byte mask values in the system. For example, it may comprise all possible values of the mask vector. Also, in one embodiment, the polarity of the byte mask is high, hence, a logic one value indicates a valid byte.

Table 2 provides one embodiment for a plurality of snoop messages. As previously mentioned in the P13923 patent application, the claimed subject matter supports a MESIF protocol, wherein the possible states of a cache line are: Modified (M), Exclusive (E), Shared (S), Invalid (I), and Forwarding (F). In one embodiment, table 2 depicts snoop messages that are directed towards caching agents. However, they may be generated by caching agents or home agents. In one embodiment, the home NID is not included in the snoop messages, but are regenerated through an address mapping process for snoop responses as well as other response. For each message name depicted, there is an associated function and the fields. Also, note that the F/S state refers to Forwarding or Shared, EF/S refers to Exclusive, Forwarding and Shared, etc . . .

Table 3 provides one embodiment for a plurality of request messages. In one embodiment, the request messages are communicated (travel) on a home channel. For example, the request messages travel on a per-address ordered home channel and are generated from a caching agent and are directed towards a home agent, wherein the destNID is the homeNID for the request messages. In this embodiment, an ordered channel refers to a channel that may be between the same pair of nodes in a similar direction to insure that a first message from a requesting node that was sent before a second message from the same requesting node is received in that order (first message is received first by the receiving node and the second message is subsequently received by the receiving node).

An illustration of a request begins with a request being generated. In one embodiment, upon a request being made, a requestor (one caching agent) sends snoops to a plurality of peer agents within the respective broadcast domain of the requestor. Likewise, the requester sends a request message to the home agent that implies a snoop of the home agent's cache hierarchy (if the home agent has a cache hierarchy). Therefore, a separate snoop message to the home agent's local caching agent is not sent.

The third column of the table 3 (labeled as “Maybe issued from”) indicates which cache states the request may be issued from. As previously described, the claimed subject matter supports a MESIF protocol, wherein the possible states of a cache line are: Modified (M), Exclusive (E), Shared (S), Invalid (I), and Forwarding (F). In one embodiment, requests from F/E/M states are valid under IA32 (Intel Architecture for 32 bit words) which include support for buried accesses.

Table 4 provides one embodiment for a plurality of writeback marker messages. As is well defined in the art, a writeback occurs when a particular cache line has been modified and the main memory (or home agent) is updated with the modified data.

In one embodiment, writeback marker messages are generated from a caching agent towards a home agent. Also, in this embodiment, the destNID is the homeNID for writeback marker messages. The writeback is initiated with one of the three WbMto* messages (either WbMtoI, WbMtoS, WbMtoE) in the home channel and the data is sent asynchronously via a Wb*Data message, such as, WbIData, WbSData, WbEdata in the response channel. The WbIData, WbSData, and WbEdata reflect the new state of the cache line after being downgraded, and respectively indicate Invalid, Shared, and Exclusive states.

In one embodiment, the Wb*Data messages carry an address so as to facilitate being written out to memory independent of the arrival of an accompanying WbMto# or Rsp*Wb message. Likewise, the Wb*Data message is sent to the home agent, hence, the destNID is equal ot the home agent's NID. In one embodiment, the state information included with Wb*Data messages is matches the snoop response on an implicit writeback.

Table 5 provides one embodiment for a plurality of snoop responses. In one embodiment, the snoop responses are generated from a caching agent towards a single home agent.

In one embodiment, the destNID is equal to the home agent's ID.

In contrast, the RspFwdIWb and RspFwdSWb messages provide additional information regarding the final state of the line at the responder to the home agent. For example, the final state may be needed for recording it in a directory maintained at the home agent.

In one embodiment, the RspFwd message is used for a SnpCur snoop type.

In one embodiment, every snoop or Fwd* message results in the generation of a snoop response, however, a Fwd* message never causes any of the following snoop responses: RspCnflt, RspCnfltOwn, RspFwdS, or RspFwdSWb.

In one embodiment, RspCnfltOwn is utilized in the event that a snoop responder has a conflicting outstanding request and an M(modified) state copy of the cache line. In contrast, RspIWb is utilized in the event that a owner cannot or should not respond directly to the requester, rather, it does a writeback to the home. In this embodiment, the home is responsible for responding to the requestor upon receiving the WbIData.

In one embodiment, RspSWb may be used by peer caching agents for responding to non-RFO (Request for Ownership) snoops. Likewise, RspSWb may be used for SnpCode hits on a cache line with a modified state. For example, a desktop memory hub type device may utilize SnpCode for Input/Output Direct Memory Access (IO DMA) read operations. DMA allows for Input/Output (IO) devices to read from or write to main memory. Finally, RspSWb may be used in any event that prefers a first response to the home agent.

Table 6 provides one embodiment for an acknowledgment message. In one embodiment, the depicted acknowledge message travels on a home channel. In the same embodiment, the AckCnflt message indicates an acknowledgment receipt and is generated when:
1) a requestor has received a (DataC_* or Gnte) response and either a (Cmp or FrcAckCnflt) from the home agent; and
2) the requestor has received a conflicting snoop OR the requestor received a FrcAckCnflt from the home agent instead of a Cmp message.
   In one embodiment, the CMP message is a response channel message and performs a function of responding that all snoop responses are gathered and did not result in a conflict. In one embodiment, the FrcAckCnflt message is a response channel message and performs a function of responding that all snoop responses are gathered and forcing an AckCnflt message.

Likewise, in one embodiment, all writeback (WbMto*) messages (earlier described in connection with table 4) send a AckCnflt message under the same preceding rules. A more detailed discussion of DataC and FrckAckCnflt messages follows in connection with Tables 7 and 8.

Table 7 provides one embodiment for a plurality of response channel data messages. In one embodiment, the depicted data messages travel on a response channel. In the same embodiment, the data messages comprise a cache line of data that is aligned on a cache line boundary.

The DataC_* messages (DataC_F/S, DataC_I, etc . . . ) are sent to the requesting caching agent, hence, the requester NID is the destNID.

In one embodiment, the DataC_S and DataC_F messages share an identical opcode for supporting caching agents that do not support the Forwarding state or have the Forwarding state being disabled by the caching agent. Therefore, DataC_F message is not allowed and only DataC_S message is supported. In contrast, in another embodiment, both DataC_S and DataC_F messages are supported for caching agents that support the Forwarding state.

The DataC_*_Cmp variants are semantically equivalent to the separate DataC_* and Cmp messages. Similarly, the DataC_*_FrcAckCnflt messages are semantically equivalent to the separate DataC_* and FrcAckCnflt messages. For example, there lacks a DataC_M_FrcAckCnflt because this message is only sent from a home agent and the data from the home agent is clean with respect to main memory.

For the Wb*Data* messages, the state information is included and will match the snoop response on an implicit writeback. For example, Rsp*IWb [symbol] WbIData, Rsp*SWb [symbol] WbSData and matches the WbMto* message for an explicit writeback, for example, WbMtoI [symbol] WbSData, WbMtoE [symbol] WbEData). In one embodiment, the state qualifiers on the Wb*Data* messages are provided for easing manipulation of directory information at a home agent in a directory based controller.

Table 8 provides one embodiment for a plurality of response channel grant messages. In one embodiment, the grant messages are used to grant ownership for a cache line without sending the data. In this same embodiment, the grant messages are always sent to the requesting caching agent, hence, the destNID is equal to the requesting cache agent's NID. In this same embodiment, the GntE message is combined with either a Cmp or a FrcAckCnflt message.

Table 9 provides one embodiment for a plurality of response channel completions and forces messages. In one embodiment, the response channel completions and forces messages are sent to the caching agent that is the current owner of the cache line of the request. For example, for every request, a requestor receives a response (GntE or one of the DataC_* message) and either a Cmp or FrcAckCnflt when the home agent gathers all the snoop responses. In this same embodiment, a GntE message is combined with the Cmp/FrcAckCnflt. Also, for the Cmp or FrcAckCnflt, the destNID is the requestor's NID. In this same embodiment, the home agent generates a FrcAckCnflt upon detection of potential conflicts with respect to the current owner. Alternatively, it may send a FrcAckCnflt.

In one embodiment, the home agent may utilize the Cmp_Fwd* (Cmp_FwdCode, Cmp_FwdInvOwn, and Cmp_FwdInvtoE) for extracting data and/or ownership from the current owner under conflict cases. In this same embodiment, a symmetry exists between the behavior of Cmp_Fwd* messages and their counterpart snoop messages. For example, the destNID, destTID, and homeNID uniquely identify the owner's request entry, while the reqNID, reqTID, and homeNID uniquely identify the requestor's request entry, which is the target of the forward.

As discussed earlier, the claimed subject matter facilitates and defines a messaging protocol for a caching agent interface. For example, the messaging protocol defines the messages that may and/or must be sent and received during predetermined phases of a transaction. Likewise, the caching agent state must be modified on receipt of each message.

In one embodiment, one method for a flow of a request is as follows. The caching agent issues a request message (as discussed earlier in connection with Table 3) to the home agent and a corresponding snoop message (as discussed earlier in connection with Table 2) to each peer caching agent, as defined by each caching agent's PeerAgents parameter. Thus, each caching agent is configured with a list of peer agents that is responsible for snooping (as defined by PeerAgents parameter). As previously discussed in one embodiment, the request messages and snoop messages travel on a home channel and a snoop channel, respectively. In the same embodiment, the PeerAgents parameter is a configurable parameter.

In the preceding embodiment, a request may be in any of three phases for a given address. For example, it can be in a Null phase (no outstanding request), or a Request phase (initiated with a Rd* message or InvltoE message being sent and terminates with a receipt of DatC_*/GntE AND Cmp/FrcAckCnflt messages), or an AckCnflt Phase (occurs at termination of Request Phase if a RspCnflt* has been sent during the Request Phase (in response to a conflicting snoop) OR a FrcAckCnflt was received. The AckCnflt phase is initiated with sending an AckCnflt message and terminates upon receipt of a Cmp/Cmp_Fwd* message.

Similarly, as in the preceding embodiment, a writeback may be in any of three phases for a given address. For example, it can be in a Null phase (no outstanding request), or a Writeback phase (initiated with a WbMto* message and terminates with a receipt of Cmp/FrcAckCnflt message), or an AckCnflt Phase (occurs at termination of Writeback Phase if a RspCnflt* has been sent during the Request Phase (in response to a conflicting snoop) OR a FrcAckCnflt was received. The AckCnflt phase is initiated with sending an AckCnflt message and terminates upon receipt of a Cmp/Cmp_Fwd* message.

For both of the preceding examples of phases for requests and writebacks, the AckCnflt phases may be utilized in the presence of address conflicts.

As previously discussed in connection with Table 2 and the P13923 patent application, the claimed subject matter supports a MESIF protocol, wherein the possible states of a cache line are: Modified (M), Exclusive (E), Shared (S), Invalid (I), and Forwarding (F). Table 10 depicts one embodiment of utilizing MESIF states. The left most column lists each of the MESIF states. The next column, Clean/Dirty, indicates whether the value of the data in the cache matches the data stored in memory. For example, if there is a match, then it is clean, otherwise, it is dirty (as evidenced by the Modified state). The next column, May Write, indicates whether one can update the data with a write operation. The next column, May Forward, indicates whether the cache state is able to respond to at least some snoop types. For example, in one embodiment, the Modified and Exclusive state can forward DataC_[M or E] to an ownership snoop (SnpInvOwn) or DataC_[F/SI] to non-ownership snoops (SnpData, SnpCode, and SnpCur].

FIG. 2 is a flowchart to depict a caching agent's response to a snoop as utilized by one embodiment. The figure depicts a flow for deciding on a peer caching agent's response to an incoming snoop based at least in part on whether the respective peer agent has a conflicting outstanding request or writeback. If so, a response is chosen from Table 12, otherwise, a response is chosen from Table 11, which will be discussed in the next few paragraphs.

In one embodiment, a peer agent's response to an incoming snoop is selected from Table 11 in the absence of a conflicting outstanding request (i.e. Null Phase). Also, Table 11 depicts the cache state transitions in response to incoming snoops, response to requester, and response to home agent

In the same embodiment, a peer agent's response to an incoming snoop is selected from Table 12 in the event of a conflicting outstanding request (in either a Request Phase or Writeback in Writeback Phase). Also, Table 12 depicts the cache state transitions in response to incoming snoops, response to requester, and response to home agent. If it is a request, the transitions are valid until the DataC_* message arrives. Subsequently, DataC_* arrives and the valid response to a home agent is RspCnflt, until the Cmp/FrcAckCnflt has been received. Hence, during this interval between Data_C* and Cmp/FrcAckCnflt, the cache state is unaffected by incoming conflicting snoops.

In one embodiment, an incoming snoop for a peer agent with a conflicting outstanding request or writeback which is in AckCnflt phase is blocked or buffered by the peer caching agent. In the same embodiment, the home agent responds to the AckCnflt with a Cmp message, hence, the transaction is complete. For example, in one aspect, the Cmp_Fwd* is provided as a mechanism for allowing the home agent for extracting data and ownership from the owner without relying on forward progress on the snoop channel. Table 13 depicts the state transitions in response to an incoming Cmp_Fwd* message.

FIG. 3 depicts a point to point system with one or more processors. The claimed subject matter comprises several embodiments, one with one processor 306, one with two processors (P) 302 and one with four processors (P) 304. In embodiments 302 and 304, each processor is coupled to a memory (M) and is connected to each processor via a network fabric may comprise either or all of: a link layer, a protocol layer, a routing layer, a transport layer, and a physical layer. The fabric facilitates transporting messages from one protocol (home or caching agent) to another protocol for a point to point network. As previously described, the system of a network fabric supports any of the embodiments depicted in connection with FIGS. 1-2 and Tables 1-13.

For embodiment 306, the uni-processor P is coupled to graphics and memory control, depicted as IO+M+F, via a network fabric link that corresponds to a layered protocol scheme. The graphics and memory control is coupled to memory and is capable of receiving and transmitting via PCI Express Links. Likewise, the graphics and memory control is coupled to the ICH. Furthermore, the ICH is coupled to a firmware hub (FWH) via a LPC bus. Also, for a different uni-processor embodiment, the processor would have external network fabric links. The processor may have multiple cores with split or shared caches with each core coupled to a Xbar router and a non-routing global links interface. Thus, the external network fabric links are coupled to the Xbar router and a non-routing global links interface.

Although the claimed subject matter has been described with reference to specific embodiments, this description is not meant to be construed in a limiting sense. Various modifications of the disclosed embodiment, as well as alternative embodiments of the claimed subject matter, will become apparent to persons skilled in the art upon reference to the description of the claimed subject matter. It is contemplated, therefore, that such modifications can be made without departing from the spirit or scope of the claimed subject matter as defined in the appended claims

1. A messaging protocol for a plurality of caching agents and a plurality of home agents coupled via a network fabric comprising:
the plurality of caching agents support to support MESIF cache states and at least one of the plurality of home agents to determine a winner of conflict for an address among at least two of the plurality of caching agents; and
at least one of the plurality of home agents to request the data from an owner to be sent to the winner.

2. The messaging protocol of claim 1 wherein the network fabric adheres to a layered protocol scheme.

3. The messaging protocol of claim 2 wherein the layered protocol scheme comprises at least one of a link layer, a protocol layer, a routing layer, a transport layer, and a physical layer.

4. The messaging protocol of claim 1 wherein at least one of the plurality of caching agents acknowledges the conflict by sending an AckCnflt message to at least one of the plurality of home agents.

5. The messaging protocol of claim 1 wherein the home agent receives messages via an ordered home channel.

6. A messaging protocol for a plurality of caching agents and a plurality of home agents coupled via a network fabric comprising:
the plurality of caching agents support to support MESIF cache states; and
a plurality of messages in the network fabric travel on one of three protocol virtual channels, home, response, and snoop.

7. The messaging protocol of claim 6 wherein the network fabric adheres to a layered protocol scheme.

8. The messaging protocol of claim 7 wherein the layered protocol scheme comprises at least one of a link layer, a protocol layer, a routing layer, a transport layer, and a physical layer.

9. The messaging protocol of claim 6 wherein a request message travels on a per-address ordered home channel and is generated from at least one of the plurality of caching agents and is directed towards at least one of the plurality of home agents.

10. The messaging protocol of claim 6 wherein a writeback marker message travels on a per-address ordered home channel and is generated from at least one of the plurality of caching agents and is directed towards at least one of the plurality of home agents.

11. The messaging protocol of claim 10 wherein the writeback marker message comprises a destNID that is equivalent to the homeNID.

12. The messaging protocol of claim 6 wherein the plurality of caching agents are able to:
make read and write requests into a coherent memory space;
hold cached copies of pieces of the coherent memory space; and
supply a plurality of cached copies.

13. The messaging protocol of claim 6 wherein the plurality of home agents are able to guard a piece of the coherent memory space and perform the following duties:
to track cache state transitions from the plurality of caching agents;
to manage conflicts among the plurality of caching agents
to interface to a memory, and
to provide data and may provide ownership in response to a request if one of the plurality of caching agents has not responded.

14. The messaging protocol of claim of claim 13 wherein the memory is a DRAM.

15. A messaging protocol for a plurality of caching agents and a plurality of home agents coupled via a network fabric comprising:
the plurality of caching agents that support MESI cache states and can disable a forward state and at least one of the plurality of home agents to determine a winner of conflict for an address among at least two of the plurality of caching agents; and
at least one of the plurality of home agents to request the data from an owner to be sent to the winner.

16. The messaging protocol of claim 15 wherein the network fabric adheres to a layered protocol scheme.

17. The messaging protocol of claim 16 wherein the layered protocol scheme comprises at least one of a link layer, a protocol layer, a routing layer, a transport layer, and a physical layer.

18. The messaging protocol of claim 16 wherein at least one of the plurality of caching agents acknowledges the conflict by sending an AckCnflt message to at least one of the plurality of home agents.

19. The messaging protocol of claim 15 wherein the home agent receives messages via an ordered home channel.

20. A messaging protocol for a plurality of caching agents and a plurality of home agents coupled via a network fabric comprising:
the plurality of caching agents that support MESI cache states and can disable a forward state; and
a plurality of messages in the network fabric travel on one of three protocol virtual channels, home, response, and snoop.

21. The messaging protocol of claim 20 wherein the network fabric adheres to a layered protocol scheme.

22. The messaging protocol of claim 21 wherein the layered protocol scheme comprises at least one of a link layer, a protocol layer, a routing layer, a transport layer, and a physical layer

23. The messaging protocol of claim 20 wherein a request message travels on a per-address ordered home channel and is generated from at least one of the plurality of caching agents and is directed towards at least one of the plurality of home agents.

24. The messaging protocol of claim 20 wherein a writeback marker message travels on a per-address ordered home channel and is generated from at least one of the plurality of caching agents and is directed towards at least one of the plurality of home agents.

25. The messaging protocol of claim 24 wherein the writeback marker message comprises a destNID that is equivalent to the homeNID.

26. The messaging protocol of claim 20 wherein the plurality of caching agents are able to:
make read and write requests into a coherent memory space;
hold cached copies of pieces of the coherent memory space; and
supply a plurality of cached copies.

27. The messaging protocol of claim 20 wherein the plurality of home agents are able to guard a piece of the coherent memory space and perform the following duties:
to track cache state transitions from the plurality of caching agents;
to manage conflicts among the plurality of caching agents
to interface to a memory, and
to provide data and may provide ownership in response to a request if one of the plurality of caching agents has not responded.

28. The messaging protocol of claim of claim 27 wherein the memory is a DRAM.

29. A caching agent interface for a messaging protocol that supports at least three protocol channels and comprises:
a snoop protocol channel to transmit a plurality of snoop messages, wherein the plurality of snoop messages may have a dependency on a plurality of home messages and a plurality of response messages that travel on a home protocol channel and response protocol channel, respectively;
the plurality of home messages may have a dependency on the plurality of response messages; and the resulting protocol hierarchy is Snoop-> Home -> Response.

30. The caching agent interface of claim 29 wherein the messages travel via a network fabric.

31. The caching agent interface of claim 30 wherein the network fabric adheres to a layered protocol scheme.

32. The caching agent interface of claim 31 wherein the layered protocol scheme comprises at least one of a link layer, a protocol layer, a routing layer, a transport layer, and a physical layer.

33. A messaging protocol to process a request comprising:
the request to be in one of at least three phases for a given address;
a first phase that is a Null phase that has no outstanding request;
a second phase that is a Request phase that is initiated with either one of two predetermined messages and terminates with a receipt of a predetermined completion message;
a third phase that is an Acknowledgement Conflict Phase.

34. The messaging protocol of claim 33 further comprising:
the messaging protocol to support a plurality of caching agents and a plurality of home agents coupled via a network fabric, the plurality of caching agents that support MESI cache states and can disable a forward state; and
a plurality of messages in the network fabric travel on one of three protocol virtual channels, home, response, and snoop.

35. The messaging protocol of claim 33 further comprising:
the messaging protocol to support a plurality of caching agents that support MESIF cache states and at least one of the plurality of home agents to determine a winner of conflict for an address among at least two of the plurality of caching agents; and
at least one of the plurality of home agents to request the data from an owner to be sent to the winner.

36. A messaging protocol to process a writeback comprising:
the writeback to be in one of at least three phases for a given address;
a first phase that is a Null phase that has no outstanding request;
a second phase that is a Writeback phase that is initiated with either a predetermined message and terminates with a receipt of a predetermined completion message;
a third phase that is an Acknowledgement Conflict Phase.

37. The messaging protocol of claim 36 further comprising:
the messaging protocol to support a plurality of caching agents and a plurality of home agents coupled via a network fabric, the plurality of caching agents that support MESI cache states and can disable a forward state; and
a plurality of messages in the network fabric travel on one of three protocol virtual channels, home, response, and snoop.

38. The messaging protocol of claim 36 further comprising:
the messaging protocol to support a plurality of caching agents that support MESIF cache states and at least one of the plurality of home agents to determine a winner of conflict for an address among at least two of the plurality of caching agents; and
at least one of the plurality of home agents to request the data from an owner to be sent to the winner.

39. A messaging protocol for generating an acknowledgment receipt comprising:
generating the acknowledgment receipt when a requester has received either one of two predetermined responses and either one of a completion or an acknowledgment conflict message from a home agent and the requestor has received a conflicting snoop or the requestor received the acknowledgment conflict message from the home agent instead of a completion (CMP) message.

40. The messaging protocol of claim 39 wherein the CMP message is a response channel message and performs a function of responding that all snoop responses are gathered and did not result in a conflict.

41. The messaging protocol of claim 39 wherein the acknowledgment conflict message is a response channel message and performs a function of responding that all snoop responses are gathered and forcing an AckCnflt message.

42. A system comprising:
a processor configuration of at least one processor to support network fabric links to a network fabric of a plurality of caching agents and a plurality of home agents;
the plurality of caching agents support to support MESIF cache states and at least one of the plurality of home agents to determine a winner of conflict for an address among at least two of the plurality of caching agents; and
at least one of the plurality of home agents to request the data from an owner to be sent to the winner.

43. The system of claim 42 wherein the processor configuration of a single processor is coupled to graphics and memory control via a network fabric link that corresponds to a layered protocol scheme.

44. The system of claim 42 wherein the processor configuration of a single processor with external network fabric links.

45. The system of claim 43 wherein the processor has multiple cores with either split or shared caches.

46. The system of claim 44 wherein the processor has multiple cores with either split or shared caches.
